(19) United States
(12) Patent Application Publication
(10) Pub. No.: US 2012/0025151 A1
(43) Pub. Date: Feb. 2, 2012

(54) CURABLE EPOXY RESIN COMPOSITION

(75) Inventors: Cherif Ghoul, Mulhouse (FR); Willi Gerig, Birr (CH); Urs Bodmer, Xiamen (CN); Vincent Tilliette, Zurich (CH)

(73) Assignee: ABB Research Ltd, Zurich (CH)

(21) Appl. No.: 13/237,470

(22) Filed: Sep. 20, 2011

Related U.S. Application Data
(63) Continuation of application No. PCT/EP2010/053420, filed on Mar. 17, 2010.

(30) Foreign Application Priority Data
Mar. 20, 2009 (EP) 09155678.7

(51) Int. Cl. C08L 63/00; H01B 1/24; H01B 1/22; B29C 47/76; C08J 3/24; C08K 3/14; C08K 3/26; C08K 3/22; C08K 3/36; C08K 3/40; C08K 3/34; C08K 3/28; H01B 1/20; C08J 3/22

(52) U.S. Cl. 252/511; 252/500; 252/512; 252/519.33; 264/102; 523/307; 523/351; 523/400; 523/457; 523/458; 523/466

(57) ABSTRACT

Curable epoxy resin composition including an epoxy resin component and a filler component and optionally a hardener component and further additives, wherein (a) the curable epoxy resin composition has been produced by separately mixing together at least a part of the epoxy resin component and at least a part of the filler component and optionally some or all of the optional additives, prior to mixing theses components with the optional hardener component and with any remaining optional additives present in the curable epoxy resin composition, and that (b) the mixing together of at least a part of the epoxy resin component and at least a part of the filler component and optionally some or all of the optional additives has been carried out at a temperature higher than the casting temperature of the curable epoxy resin composition, and electrical insulation systems made therefrom.

### RELATED APPLICATIONS

This application claims priority as a continuation application under 35 U.S.C. §120 to PCT/EP2010/053420, which was filed as an International Application on Mar. 17, 2010 designating the U.S., and which claims priority to European Application No. 09155678.7 filed in Europe on Mar. 20, 2009. The entire contents of these applications are hereby incorporated by reference in their entireties.

### FIELD

Disclosed is a curable epoxy resin composition comprising an epoxy resin component, a filler component and optionally a hardener component and further additives, which has been produced by intensively mixing together at least a part of the epoxy resin component and at least a part of the filler component and optionally some or all of the additives, under defined conditions, prior to mixing these components with the hardener component and with the remaining optional additives which are present in the curable epoxy resin composition. The resulting cured epoxy resin composition can have improved mechanical properties such as, for example, flexural properties, tensile properties or fracture toughness, combined with excellent electrical properties and is suitable for casting electrical insulations.

### BACKGROUND INFORMATION

Epoxy resin compositions are commonly used as insulating materials for electrical applications because the compositions generally have a comparatively low price, are easy to process and, after curing, yield electrical insulator systems with good electrical and mechanical properties. In order to enhance specific properties, such as mechanical and electrical properties or the thermal conductivity or to reduce cost, epoxy resins are often filled with inorganic filler materials such as silica, quartz, known silicates, aluminium oxide, aluminium trihydrate, as well as other filler materials known to be used in electrical applications. The usual way to prepare filled epoxy resin compositions is to mix all the components, i.e. the epoxy resin component, the hardener component, the filler material, and the optional further additives, at a temperature which is not higher than the casting temperature of the final epoxy resin composition. The obtained mixture is then poured into a mould and the mould is put into an oven for curing, yielding the cured electrical insulator.

Commercial markets can require that electrical devices withstand various types of tests including dielectric tests (voltage and partial discharge tests, power tests, etc.), mechanical tests (bending, torsion, vibration, pressure test, etc.), thermal and thermo-mechanical tests, etc. For some specific applications, these tests show that cured, filler-containing epoxy resin compositions are often too brittle.

In order to improve the mechanical properties and to reduce the brittleness of filler containing epoxy resin compositions, special additives, so called tougheners, are often added to the curable epoxy resin composition. However, the incorporation of such tougheners can render the production of the epoxy resin composition more complicated and can impair the thermal or thermo-mechanical properties of the cured product

### SUMMARY

According to an exemplary aspect, a curable epoxy resin composition is provided, comprising:
an epoxy resin component;
a filler component;
optionally, a hardener component; and
optionally, at least one additive,
wherein said curable epoxy resin composition is produced by separately mixing together at least a part of the epoxy resin component and at least a part of the filler component and optionally some or all of the optional at least one additive, prior to mixing theses components with the optional hardener component and with any remaining optional at least one additive present in the curable epoxy resin composition, and
wherein said mixing together of at least a part of the epoxy resin component and at least a part of the filler component and optionally some or all of the optional at least one additive is carried out at a temperature higher than a casting temperature of the curable epoxy resin composition.

According to an exemplary aspect, a curable epoxy resin composition is provided, comprising:
an epoxy resin component;
a filler component;
optionally, a hardener component; and
optionally, at least one additive,
wherein said curable epoxy resin composition is produced by separately mixing together at least a part of the epoxy resin component and at least a part of the filler component and optionally some or all of the optional at least one additive, prior to mixing theses components with the optional hardener component and with any remaining optional at least one additive present in the curable epoxy resin composition, and wherein at least a part of the epoxy resin component and at least a part of the filler component and optionally some or all of the at least one additive are separately mixed together at a temperature higher than the casting temperature of the curable epoxy resin composition.

According to an exemplary aspect, a method of producing a curable epoxy resin composition is provided, the method comprising:
separately mixing together at least a part of an epoxy resin component and at least a part of a filler component and optionally some or all of at least one additive, at a temperature higher than a casting temperature of the curable epoxy resin composition to be produced, and
mixing the resulting mixture of said components with an optional hardener component and with any remaining optional at least one additive present in the curable epoxy resin composition.

### DETAILED DESCRIPTION

According to an exemplary aspect, a curable epoxy resin composition is disclosed with improved mechanical properties, for example, with respect to brittleness, for example, without the use of additional additives. Exemplary curable epoxy resin compositions are suitable for producing therefrom electrical insulators and are compatible with vacuum casting or Automated Pressure Gelation (APG) manufacturing processes.

It has now been found that exemplary cured epoxy resin compositions with, for example, significantly improved mechanical properties, such as flexural properties, tensile properties and fracture toughness, and without impairing the electrical or thermo-mechanical properties, can be obtained, for example, when the curable epoxy resin composition comprising an epoxy resin component and a filler component and optionally a hardener component as well as further additives, is produced by intensively and separately mixing together at least a part of the epoxy resin component and at least a part of the filler component and optionally some or all of the further additives at a temperature higher than the casting temperature of the curable epoxy resin composition, prior to mixing theses components with the hardener component and with any remaining optional additives present in the curable epoxy resin composition. For this mixing process a standard mixing procedure can be used.

Disclosed is an exemplary curable epoxy resin composition comprising an epoxy resin component and a filler component and optionally a hardener component and further additives, wherein (a) said curable epoxy resin composition has been produced by separately mixing together at least a part of the epoxy resin component and at least a part of the filler component and optionally some or all of the optional additives, prior to mixing theses components with the optional hardener component and with any remaining optional additives present in the curable epoxy resin composition, and that (b) said mixing together of at least a part of the epoxy resin component and at least a part of the filler component and optionally some or all of the optional additives has been carried out at a temperature higher than the casting temperature of the curable epoxy resin composition.

Disclosed is an exemplary method of producing a curable epoxy resin composition comprising an epoxy resin component, a filler component and optionally a hardener component and further additives, wherein said method comprises the steps of separately mixing together at least a part of the epoxy resin component and at least a part of the filler component and optionally some or all of the further additives, at a temperature higher than the casting temperature of the curable epoxy resin composition to be produced, and mixing the resulting mixture of said components with the hardener component and with any remaining optional additives present in the curable epoxy resin composition.

Disclosed is an exemplary use of said curable epoxy resin composition for the production of insulation systems in electrical articles.

Disclosed is an exemplary cured epoxy resin composition, which is present in the form of an electrical insulation system, for example, in the form of an electrical insulator. Also disclosed are electrical articles comprising an electrical insulation system made according an exemplary aspect.

Disclosed is an exemplary epoxy resin component that can be used in a curable epoxy resin composition, said curable epoxy resin composition comprising an epoxy resin component, a filler component and optionally further additives, wherein said epoxy resin component has been produced by separately mixing together at least a part of the epoxy resin component and at least a part of the filler component and optionally some or all of the further additives at a temperature higher than the casting temperature of the curable epoxy resin composition to be produced with said epoxy resin component.

Disclosed is an exemplary method of producing an epoxy resin component that can be used in a curable epoxy resin composition comprising an epoxy resin component, a filler component and optionally a hardener component and further additives, wherein at least a part of the epoxy resin component and at least a part of the filler component and optionally some or all of the further additives are separately mixed together at a temperature higher than the casting temperature of the curable epoxy resin composition to be produced with said epoxy resin component.

“At least a part of the epoxy resin component”, for example, means that at least 50% by weight, for example, 65% by weight, for example, 80% by weight, for example, 90% by weight and for example, 100% by weight of the epoxy resin component are separately mixed together with at least a part of the filler component and optionally some or all of the further additives.

“At least a part of the filler component”, for example, means that at least 30% by weight, for example, 50% by weight, for example, 70% by weight, for example, 90% by weight and for example, 100% by weight of the filler component are separately mixed with the epoxy resin component and optionally with some or with all of the further additives.

For example, 100% by weight of the epoxy resin component present within the epoxy resin composition and 100% by weight of the filler component present within the epoxy resin composition and optionally some or all of the further additives can be separately mixed together at a temperature higher than the casting temperature of the curable epoxy resin composition to be produced with said epoxy resin component.

At a temperature higher than the casting temperature of the curable epoxy resin composition to be produced with said epoxy resin component, for example, means that said temperature is within the range of 60° C. to 180° C., for example, within the range of 70° C. to 170° C., for example, within the range of 80° C. to 160° C., for example, within the range of 90° C. to 140° C., and for example, within the range of 100° C. to 140° C.

Said mixing process can be, but is not necessarily, carried out under vacuum, for example, at a pressure of less than 100 mbar (<100 mbar), for example, less than 50 mbar (<50 mbar), for example, less than 20 mbar (<20 mbar) and for example, less than 10 mbar (<10 mbar).

Said mixing process can be carried out for a time period within the range of 10 minutes to twenty-four hours, for example, for a time period within the range of 30 minutes to six hours, for example, within the range of one hour to three hours.

The epoxy resin component as used in the curable epoxy resin composition can contain at least two 1,2-epoxy groups per molecule. Cycloaliphatic and cycloaromatic epoxy resin compounds that can be used can comprise unsubstituted glycidyl groups and/or glycidyl groups substituted with methyl groups. These glycidyl compounds can have an epoxy value (equiv./kg) for example, of at least three, for example, at least four and for example, at about five or higher, for example, about 5.0 to 6.1. Examples include optionally substituted epoxy resins of formula (I):

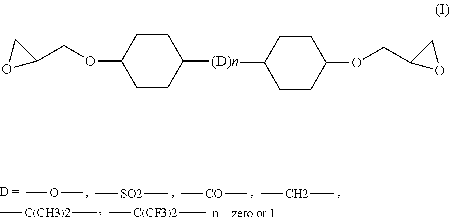

or optionally substituted epoxy resins of formula (II):

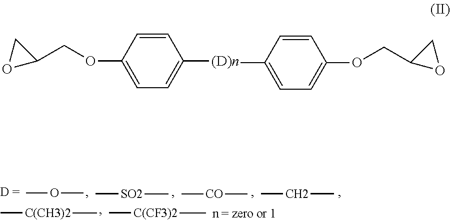

Compounds of formula (I) or formula (II) wherein D is [—(CH₂)—] or [—C(CH₃)₂—] can be used. For example, compounds of formula (II) wherein D is [—(CH₂)—] or [—C(CH₃)₂—], and for example, [—C(CH₃)₂—], i.e. diglycidylether of 2,2-bis-(4-hydroxyphenyl)-propane [diglycidylether of bisphenol A (DGEBA)] can be used. DGEBA is commercially available as an epoxy resin component, e.g. as Epilox A19-00 (Leuna Harze GmbH.) or similar products. DGEBA can have an epoxy value (equiv./kg) of at least three, for example, at least four and for example, at about five or higher, for example, about 5.0 to 6.1.

Exemplary cycloaliphatic epoxy resin compounds include Araldite® CY 184 (Huntsman Advanced Materials Ltd.), a cycloaliphatic diglycidylester epoxy resin compound having an epoxy content of 5.80-6.10 (equiv/kg).

Further epoxy resins that can be used are for example hexahydro-o-phthalic acid-bis-glycidyl ester, hexahydro-m-phthalic acid-bis-glycidyl ester or hexahydro-p-phthalic acid-bis-glycidyl ester. Exemplary epoxy resin compounds are liquid at room temperature or when heated to a temperature of up to about 100° C.

The epoxy resin composition can comprise an epoxy resin component and a filler which have been treated according to an exemplary aspect. Said epoxy resin component may optionally contain additives. Said epoxy resin component can be used in any curable epoxy resin composition, such as, for example, in hardener cured epoxy resin compositions as well as in compositions that do not contain a hardener component for curing the composition. An exemplary effect can also be obtained for compositions containing a homopolymerizable epoxy resin component, yielding a homopolymerized epoxy resin composition, or in an amine cured epoxy resin composition or in any other polymerizable epoxy resin composition. A hardener is not necessary to obtain the exemplary effect.

Numerous hardeners can be used as hardener component in epoxy resin compositions. An exemplary hardener component is an acid anhydride. Such anhydrides can be aliphatic and cycloaliphatic or aromatic polycarbonic acid anhydrides. Examples are phthalic anhydride, a tetra-hydrophtalic anhydride (THPA), a hexahydrophtalic anhydride (HHPA), a methylhydrophthalic anhydride, a methyltetrahydrophthalic anhydride (MTHPA), a methyl-hexahydrophtalic anhydride (MHHPA), or a methyl-nadic anhydride (MNA) or a mixture thereof.

MTHPA, for example, is commercially available and exists in different forms, e.g. as 4-methyl-1,2,3,6-tetrahydrophthalic anhydride or as 4-methyl-3,4,5,6-tetrahydrophthalic anhydride. For example, 4-methyl-1,2,3,6-tetrahydrophthalic anhydride and 4-methyl-3,4,5,6-tetrahydrophthalic anhydride can be used.

Methyltetrahydrophthalic anhydride (MTHPA) can be supplied commercially as a mixture containing MTHPA isomers as the main component, together with other anhydrides, such as, for example, tetrahydrophthalic anhydride (THPA), methylhexahydrophthalic anhydride (MHHPA) and/or phthalic anhydride (PA). Such mixtures may also be used within the scope of an exemplary aspect. The content of MTHPA within such a mixture can be at least 50% by weight, for example, at least 60% by weight, for example, at least 70% by weight, for example, at least 80% by weight, and for example, at least 90% by weight, calculated to the total weight of the mixture.

The hardener component within the epoxy resin composition can be present in concentrations within the range of 0.8 to 1.2 reactive group equivalents of the hardener component, calculated per one epoxy equivalent present in the epoxy resin component; for example, one reactive group equivalent of the hardener component, per one epoxy equivalent present in the epoxy resin component.

The filler component can be selected from filler materials that are suitable for use as fillers in electrical insulations. For example, said filler can be selected from the group of filler materials comprising inorganic oxides, inorganic hydroxides and inorganic oxyhydroxides, for example, silica, quartz, known silicates, aluminium oxide, aluminium trihydrate [ATH], titanium oxide or dolomite [CaMg(CO₃)₂], wollastonite, glass beads, metal nitrides, such as silicon nitride, boron nitride and aluminium nitride or metal carbides, such as silicon carbide as well as cut or continuous reinforcing fibers of suitable composition, length and diameters. Also a mixture of different fillers may be used. Examples are silica and quartz, for example, silica flour, with a SiO₂-content of about 95-98% by weight.

The filler material can have an average grain size suitable for use in electrical insulation systems, for example, within the range of 100 nm (nanometer) to 3 mm. In an exemplary embodiment, an average grain size (at least 50% of the grains) can be within the range of about 1 μm to 300 μm, for example, from 5 μm to 100 μm, or a selected mixture of such average grain sizes. The filler material can, for example, have a high surface area.

The filler component can be present in the epoxy resin composition, for example, depending on the final application of the epoxy resin composition, for example, within the range of about 50% by weight to about 80% by weight, for example, within the range of about 55% by weight to about 75% by weight, for example, at about 60% by weight to about 70% by weight, for example, at about 65% by weight to about 70% by weight, calculated to the total weight of the epoxy resin composition.

The filler material optionally may be present in a “porous” form. As a porous filler material, which optionally may be coated, is understood, that the density of said filler material is within the range of 60% to 80%, compared to the density of the filler material in non-porous form. Such porous filler materials can have a higher total surface area than the non-porous material. Said surface area can be higher than 0.3 m²/g (BET m²/g) and, for example, higher than 0.4 m²/g (BET) and, for example, is within the range of 0.4 m²/g (BET) to 100 m²/g (BET), for example, within the range of 0.5 m²/g (BET) to 80 m²/g (BET).

The curable epoxy resin composition can comprise an electrically conductive or semi-conductive filler material, such that the electrical volume resistivity of the cured epoxy resin composition is reduced, for example, within the range of about 10E9 Ω.cm to 10E14 Ω.cm, for example, within the range of about 10E10 Ω.cm to 10E14 Ω.cm, for example, within the range of about 10E12 Ω.cm to 10E14 Ω.cm.

Further conductive or semi-conductive material can be selected from doped metal oxides, antimony trioxide, zinc oxide, carbon black, or metal coated insulating filler. The semi-conductive or conductive filler can be present in the epoxy resin composition, for example, depending on the final application of the epoxy resin composition, for example, within the range of about 0.0001% by weight to about 1% by weight, for example, within the range of about 0.001% by weight to about 0.5% by weight, for example, at about 0.001% by weight to about 0.01% by weight, calculated to the total weight of the epoxy resin composition.

The curable epoxy resin composition can comprise a curing agent for enhancing the polymerization of the epoxy resin with the hardener. Further additives can be selected from hydrophobic compounds including, for example, silicones, wetting/dispersing agents, plasticizers, antioxidants, light absorbers, pigments, flame retardants, fibers, tougheners and other additives generally used in electrical applications.

Exemplary curing agents can include, for example, tertiary amines, such as benzyldimethylamine or amine-complexes such as complexes of tertiary amines with boron trichloride or boron trifluoride; urea derivatives, such as N-4-chlorophenyl-N′,N′-dimethylurea (Monuron); optionally substituted imidazoles such as imidazole or 2-phenyl-imidazole. Examples include tertiary amines, for example, 1-substituted imidazole and/or N,N-dimethylbenzylamine, such as 1-alkyl imidazoles which may or may not be substituted also in the 2-position, such as 1-methyl imidazole or 1-isopropyl-2-methyl imidazole. 1-methyl imidazole can be used. The amount of catalyst used can be a concentration of about 0.1% to 2.0% by weight, calculated to the weight of the epoxy resin component present in the composition.

Suitable hydrophobic compounds or mixtures of such compounds, for example, for improving the self-healing properties of the electrical insulator can be selected from the group comprising flowable fluorinated or chlorinated hydrocarbons which contain —CH₂-units, —CHF-units, —CF₂-units, —CF₃-units, —CHCl-units, —C(Cl)₂-units, —C(Cl)₃-units, or mixtures thereof; or a cyclic, linear or branched flowable organopolysiloxane. Such compounds, also in encapsulated form, can be used.

Suitable polysiloxanes can be, for example, linear, branched, cross-linked or cyclic. For example, the polysiloxanes can be composed of —[Si(R)(R)O]-groups, wherein R independently of each other is an unsubstituted or substituted, for example, fluorinated, alkyl radical having from 1 to 4 carbon atoms, or phenyl, for example, methyl, and wherein said substituent R may carry reactive groups, such as hydroxyl or epoxy groups. Non-cyclic siloxane compounds, for example, on average can have about from 20 to 5000, for example, 50-2000, —[Si(R)(R)O]-groups. Exemplary cyclic siloxane compounds are those comprising 4-12, and, for example, 4-8, —[Si(R)(R)O]-units.

The hydrophobic compound can be added to the epoxy resin composition, for example, in an amount of from 0.1% to 10%, for example, in an amount of from 0.25% to 5% by weight, for example, in an amount of from 0.25% to 3% by weight, calculated to the weight of the weight of the epoxy resin component present.

Suitable processes for casting curable epoxy resin compositions, including an exemplary curable epoxy resin composition, can include, for example the Vacuum Casting Process and the Automated Pressure Gelation (APG) Process. These processes can be carried out at a casting temperature within the range of room temperature to 150° C., for example, within the range of 50° C. to 150° C., for example, at a temperature of about 65° C. For example, an exemplary epoxy resin component, which has been obtained by separately mixing together at least a part of the epoxy resin component and at least a part of the filler component and optionally some or all of the further additives, at a temperature higher than the casting temperature of the curable epoxy resin composition to be produced, can be cooled down after mixing to at least the casting temperature of the final curable epoxy resin composition, before mixing said epoxy resin component with the hardener and with any remaining optional additives present in the curable epoxy resin composition.

The uncured epoxy resin composition can be cured at a temperature of, for example, room temperature to about 280° C., for example, within the range of 50° C. to 280° C., for example, within the range of 100° C. to 200° C., for example, within the range of 100° C. to 170° C., and for example, at about 130° C. and during a curing time within the range of about 30 minutes to about 10 hours. Curing can be possible also at lower temperatures, wherein at lower temperatures complete curing can last up to several days depending on, for example, the catalyst present and its concentration. The Vacuum Casting Process and the Automated Pressure Gelation (APG) Process when being applied to an exemplary composition can include such a curing step in the mold for a time sufficient to shape the epoxy resin composition into its final infusible three dimensional structure.

Exemplary uses of the electrical insulation systems produced with epoxy resin compositions according to an exemplary aspect include dry-type transformers, cable terminations, insulators for gas insulated switchgears, for example, cast coils for dry type distribution transformers, for example, vacuum cast dry distribution transformers, which within the resin structure contain electrical conductors, and in the casting of electrical components such as bushings, switches, insulators, sensors, converters, cable end seals and insulators. These can be produced also for medium and high-voltage insulations for indoor and outdoor use, like breakers or switchgear applications; medium and high voltage bushings; as long-rod, composite and cap-type insulators, and also for base insulators in the medium-voltage sector, in the production of insulators associated with outdoor power switches, measuring transducers, leadthroughs, and overvoltage protectors, in switchgear constructions, in power switches, and electrical machines, as coating materials for transistors and other semiconductor elements and/or to impregnate electrical components. The following examples illustrate non-limiting exemplary aspects.

### EXAMPLES 1, 3 and 5 (REFERENCE EXAMPLES)

In Example 1, a Reference Example as a standard silica filled epoxy resin composition was prepared according to the standard mixing procedure. All the components apart from the catalyst were mixed during 1 hour at 65° C. under vacuum (<1 mbar). Then the catalyst was added and the mixture was stirred 10 minutes at 65° C. under vacuum (<1 mbar), before being poured into the moulds under vacuum (30 mbar). The moulds were then put in an oven for curing and post-curing.

In Example 3, a Reference Example as a standard aluminium oxide filled solid epoxy resin composition was prepared according to a mixing procedure. The three components (epoxy, hardener and filler) were mixed at 125° C. under vacuum (<1 mbar) until the hardener was completely dissolved. The material was then poured into moulds under vacuum (about 30 mbar) and the moulds were put in an oven at 130° C. for curing.

In Example 5, a Reference Example as a standard aluminium oxide filled epoxy resin based on liquid components was prepared according to a mixing method. All the components apart from the catalyst were first mixed together at 70° C. under vacuum (<1 mbar) until a homogeneous mixture was obtained, then the catalyst was slowly added and the mixture stirred under vacuum for additional 10 minutes. The resin was poured into moulds under vacuum (30 mbars), and put in an oven for curing and post-curing the resin.

The properties of the Reference Examples 1, 3 and 5 are listed in Table 1.

### EXAMPLES 2, 4 AND 6

In Example 2, the same components as in Reference Example 1 were used but the mixing procedure according to an exemplary aspect was applied. The epoxy resin component was first mixed with the silica filler and the flexibilizer at 140° C. during 1 hour under vacuum (<1 mbar). The mixture was then cooled to 65° C. and mixed with the hardener under vacuum (<1 mbar). The catalyst was finally added, the mixture was stirred for 10 minutes and poured into moulds under vacuum (30 mbar). The moulds were put in an oven for curing and post-curing.

In Example 4, the same components were used as in Reference Example 3 but the mixing procedure according to an exemplary aspect was used. The epoxy resin component was first pre-mixed with the filler component at 130° C. during 1 hour under vacuum (<1 mbar). Then, the hardener was added to this premix, and the mixture stirred until the hardener was completely dissolved. The final mixture was then poured into mould under vacuum (about 30 mbar), and put in an oven at 130° C. for curing and post-curing the resin.

In Example 6, the same components were used as in Example 5, but the mixing procedure according to an exemplary aspect was used. The epoxy resin was first pre-mixed with the filler and the flexibilizer at a temperature of 140° C. during 1 hour; then the mixture was cooled down to 70° C., and the hardener was added. This mixture was stirred during 1 hour at 70° C. under vacuum (<1 mbar), the catalyst was finally added and the blend stirred under vacuum for additional 10 minutes. The obtained epoxy resin composition was then poured into the moulds under vacuum (about 30 mbar) and the moulds were put in an oven at 130° C. for curing and post-curing the resin.

The properties of the Examples 2, 4 and 6 are also listed in Table 1. The comparative results as shown in Table 1 show that the cured epoxy resin compositions made according to Examples 2, 4, and 6 exhibit significantly improved mechanical properties compared to the Reference Examples 1, 3, and 5, without impairing the thermo-mechanical properties.

TABLE 1

| | MATERIAL | | | | | |
|---|---|---|---|---|---|---|
| | 1 | 2 | 3 | 4 | 5 | 6 |
| INGREDIENTS (phr) | SiO2 filled epoxy | | Al2O3 filled epoxy | | Al2O3 filled epoxy | |
| Epoxy (1) EEW = 350-450 | | | 100 | 100 | | |
| DGEBA (2) EEW = 160-220 | 100 | 100 | | | 100 | 100 |
| Phtalic anhydride (3) MW = 130-160 | | | 30 | 30 | | |
| Phtalic anhydride (4) MW = 150-200 | 89 | 89 | | | 84 | 84 |
| Polyglycol (5) | 22 | 22 | | | 10 | 10 |
| Alumina (6) | | | 190 | 190 | 292 | 292 |
| Silica (7) | 370 | 370 | | | | |
| Imidazole catalyst (8) | 0.5 | 0.5 | | | 0.5 | 0.5 |
| Mixing process | Standard | New | Standard | New | Standard | New |

MECHANICAL PROPERTIES
Flexural properties ISO 178

| | | | | | | |
|---|---|---|---|---|---|---|
| Flexural strength (MPa) | 120 MPa | 150 MPa | 110 MPa | 140 MPa | 110 MPa | 140 MPa |
| Elongation at break (%) | 1.40% | 1.80% | 1.60% | 2.40% | 1.20% | 2% |

Tensile properties ISO 527

| | | | | | | |
|---|---|---|---|---|---|---|
| Tensile strength (MPa) | 70 MPa | 85 MPa | 70 MPa | 75 MPa | 55 MPa | 75 MPa |
| Young modulus (GPa) | 10 GPa | 10 GPa | 7.5 GPa | 7.5 GPa | 8 GPa | 8 GPa |
| Elongation at break (%) | 0.85% | 1.10% | 1.00% | 1.40% | 0.70% | 1.20% |

Fracture toughness Ciba Geigy Double Torsion Test

| | | | | | | |
|---|---|---|---|---|---|---|
| K1c (MPa · m½) | 2 MPa · m½ | 2.7 MPa · m½ | 1.6 MPa · m½ | 1.7 MPa · m½ | 1.6 MPa · m½ | 1.8 MPa · m½ |
| G1c (J/m2) | 360 J/m2 | 560 J/m2 | 330 J/m2 | 330 J/m2 | 280 J/m2 | 310 J/m2 |

Thermomechanical properties

| | | | | | | |
|---|---|---|---|---|---|---|
| Tg (° C.) | 85° C. | 85° C. | 120° C. | 120° C. | 125° C. | 125° C. |

(1), (2), (3), (5) supplied by Hexion
(4) Supplied by Polynt
(6) Supplied by Almatis
(7) Supplied by Quarzwerke
(8) Supplied by Huntsman
EEW = epoxy equivalent weight
MW = molecular weight

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A curable epoxy resin composition, comprising:
an epoxy resin component;
a filler component;
optionally, a hardener component; and
optionally, at least one additive,
wherein said curable epoxy resin composition is produced by separately mixing together at least a part of the epoxy resin component and at least a part of the filler component and optionally some or all of the optional at least one additive, prior to mixing theses components with the optional hardener component and with any remaining optional at least one additive present in the curable epoxy resin composition, and
wherein said mixing together of at least a part of the epoxy resin component and at least a part of the filler component and optionally some or all of the optional at least one additive is carried out at a temperature higher than a casting temperature of the curable epoxy resin composition.

2. The curable epoxy resin composition according to claim 1, wherein at least 50% by weight of the epoxy resin component is separately mixed together with at least a part of the filler component and optionally with some or with all of the optional at least one additive.

3. The curable epoxy resin composition according to claim 1, wherein at least 30% by weight of the filler component is separately mixed with the epoxy resin component and optionally with some or with all of the optional at least one additive.

4. The curable epoxy resin composition according to claim 1, wherein 100% by weight of the epoxy resin component present within the epoxy resin composition and 100% by weight of the filler component present within the epoxy resin composition and optionally some or all of the at least one additive are separately mixed together at a temperature higher than the casting temperature of the curable epoxy resin composition to be produced with said epoxy resin component.

5. The curable epoxy resin composition according to claim 1, wherein the epoxy resin component and the filler component and optionally some or all of the at least one additive are mixed at a temperature within the range of 60° C. to 180° C.

6. The curable epoxy resin composition according to claim 1, wherein said mixing process is carried out under vacuum.

7. The curable epoxy resin composition according to claim 1, wherein said mixing process is carried out for a time period within the range of ten minutes to twenty-four hours.

8. The curable epoxy resin composition according to claim 1, wherein the epoxy resin component is a cycloaliphatic or cycloaromatic epoxy resin compound comprising unsubstituted glycidyl groups and/or glycidyl groups substituted with methyl groups, wherein the glycidyl compounds have an epoxy value (equiv./kg) of at least two 1,2-epoxy groups per molecule.

9. The curable epoxy resin composition according to claim 1, wherein the epoxy resin component is hexahydro-o-phthalic acid-bis-glycidyl ester, hexahydro-m-phthalic acid-bis-glycidyl ester or hexahydro-p-phthalic acid-bis-glycidyl ester.

10. The curable epoxy resin composition according to claim 1, wherein said epoxy resin composition contains a homopolymerizable epoxy resin component and does not contain a hardener component for curing the composition.

11. The curable epoxy resin composition according to claim 1, wherein said epoxy resin composition contains a hardener component for curing the composition.

12. The curable epoxy resin composition according to claim 11, wherein said hardener is an acid anhydride.

13. The curable epoxy resin composition according to claim 1, wherein said filler component is filler material that is suitable for use in electrical insulations.

14. The curable epoxy resin composition according to claim 1, wherein said curable epoxy resin composition further comprises an electrically conductive or semi-conductive filler material, in a quantity such that the electrical volume resistivity of the cured epoxy resin composition is reduced.

15. The curable epoxy resin composition according to claim 14, wherein said electrically conductive or semi-conductive filler material comprises a doped metal oxide, antimony trioxide, zinc oxide, carbon black, or metal coated insulating filler.

16. The curable epoxy resin composition according to claim 14, wherein said electrically conductive or semi-conductive filler material is in the epoxy resin composition within the range of about 0.0001% by weight to about 1% by weight, calculated to the total weight of the epoxy resin composition.

17. The curable epoxy resin composition according to claim 1, wherein the mineral filler has an average grain size within the range of 100 nm to 3 mm.

18. The curable epoxy resin composition according to claim 1, wherein the mineral filler is present in the epoxy resin composition within the range of about 50% by weight to about 80% by weight, calculated to the total weight of the epoxy resin composition.

19. The curable epoxy resin composition according to claim 1, wherein the mineral filler is present in a porous form having a density within the range of 60% to 80%, compared to the density of the filler material in a non-porous form, and a surface area which is higher than 0.3 m²/g (BET m²/g).

20. The curable epoxy resin composition according to claim 1, wherein said curable epoxy resin composition comprises at least one additive selected from the group consisting of a curing agent, hydrophobic compound including a silicone, wetting/dispersing agent, plasticizer, antioxidant, light absorber, pigment, flame retardant, fiber, toughener and a combination thereof.

21. A method of producing the curable epoxy resin composition according to claim 1, wherein said method comprises:
separately mixing together at least a part of the epoxy resin component and at least a part of the filler component and optionally some or all of the at least one additive, at a temperature higher than the casting temperature of the curable epoxy resin composition to be produced, and
mixing the resulting mixture of said components with the optional hardener component and with any remaining optional at least one additive present in the curable epoxy resin composition.

22. A method of curing the curable epoxy resin composition according to claim 1, optionally under the application of a vacuum, wherein the curable epoxy resin composition in an uncured state is heated to a temperature within the range of 50° C. to 280° C. during a curing time within the range of about 30 minutes to about 10 hours.

23. The method according to claim 22, wherein the curable epoxy resin composition is subjected to a vacuum casting process or an automated pressure gelation (APG) process, wherein said vacuum casting process or automated pressure gelation (APG) process is carried out at a casting temperature within the range of 50° C. to 150° C., and in a mold for a time sufficient to shape the epoxy resin composition into its final infusible three dimensional structure.

24. An insulation system in an electrical article, comprising a cured epoxy resin composition formed from the curable epoxy resin composition according to claim 1.

25. A cured epoxy resin composition produced by the method according to claim 22, wherein the cured epoxy resin composition is an electrical insulation system.

26. A curable epoxy resin composition, comprising:
an epoxy resin component;
a filler component;
optionally, a hardener component; and
optionally, at least one additive,
wherein said curable epoxy resin composition is produced by separately mixing together at least a part of the epoxy resin component and at least a part of the filler component and optionally some or all of the optional at least one additive, prior to mixing theses components with the optional hardener component and with any remaining optional at least one additive present in the curable epoxy resin composition, and wherein at least a part of the epoxy resin component and at least a part of the filler component and optionally some or all of the at least one additive are separately mixed together at a temperature higher than the casting temperature of the curable epoxy resin composition.

27. The curable epoxy resin composition according to claim 1, wherein at least 80% by weight of the epoxy resin component is separately mixed together with at least a part of the filler component and optionally with some or with all of the optional at least one additive.

28. The curable epoxy resin composition according to claim 1, wherein at least 70% by weight of the filler component is separately mixed with the epoxy resin component and optionally with some or with all of the optional at least one additive.

29. The curable epoxy resin composition according to claim 1, wherein the epoxy resin component and the filler component and optionally some or all of the at least one additive are mixed at a temperature within the range of 80° C. to 160° C.

30. The curable epoxy resin composition according to claim 1, wherein said mixing process is carried out at a pressure of less than 50 mbar.

31. The curable epoxy resin composition according to claim 1, wherein said mixing process is carried out for a time period within the range of thirty minutes to six hours.

32. The curable epoxy resin composition according to claim 8, wherein the glycidyl compounds have an epoxy value (equiv./kg) of at least four.

33. The curable epoxy resin composition according to claim 11, wherein said hardener is an aliphatic and cycloaliphatic or aromatic polycarbonic acid anhydride.

34. The curable epoxy resin composition according to claim 11, wherein said hardener is a phthalic anhydride, a tetra-hydrophtalic anhydride (THPA), a hexahydrophtalic anhydride (HHPA), a methylhydrophthalic anhydride, a methyltetrahydrophthalic anhydride (MTHPA), a methyl-hexahydrophtalic anhydride (MHHPA), a methyl-nadic anhydride (MNA) or a mixture thereof.

35. The curable epoxy resin composition according to claim 1, wherein said filler component is selected from the group consisting of an inorganic oxide, inorganic hydroxide and inorganic oxyhydroxide.

36. The curable epoxy resin composition according to claim 1, wherein said filler component is selected from the group consisting of silica, quartz, silicate, aluminum oxide, aluminum trihydrate [ATH], titanium oxide, dolomite (CaMg(CO₃)₂), wollastonite, glass beads, metal nitride, metal carbide, cut or continuous reinforcing fibers, and a mixture thereof.

37. The curable epoxy resin composition according to claim 1, wherein said curable epoxy resin composition further comprises an electrically conductive or semi-conductive filler material, in a quantity such that the electrical volume resistivity of the cured epoxy resin composition is reduced within the range of about 10E10 Ω.cm to 10E14 Ω.cm.

38. The curable epoxy resin composition according to claim 14, wherein said electrically conductive or semi-conductive filler material is in the epoxy resin composition within the range of about 0.001% by weight to about 0.01% by weight, calculated to the total weight of the epoxy resin composition.

39. The curable epoxy resin composition according to claim 1, wherein the mineral filler has an average grain size within the range of about 1 μm to 300 μm.

40. The curable epoxy resin composition according to claim 1, wherein the mineral filler is present in the epoxy resin composition within the range of about 60% by weight to about 70% by weight, calculated to the total weight of the epoxy resin composition.

41. The curable epoxy resin composition according to claim 1, wherein the mineral filler is present in a porous form having a density within the range of 60% to 80%, compared to the density of the filler material in a non-porous form, and a surface area within the range of 0.4 m²/g (BET) to 100 m²/g (BET).

42. A method of curing the curable epoxy resin composition according to claim 1, optionally under the application of a vacuum, wherein the curable epoxy resin composition in an uncured state is heated to a temperature within the range of 100° C. to 170° C. during a curing time within the range of about 30 minutes to about 10 hours.

43. A method of producing a curable epoxy resin composition, the method comprising:
separately mixing together at least a part of an epoxy resin component and at least a part of a filler component and optionally some or all of at least one additive, at a temperature higher than a casting temperature of the curable epoxy resin composition to be produced, and
mixing the resulting mixture of said components with an optional hardener component and with any remaining optional at least one additive present in the curable epoxy resin composition.
